(19) United States
(12) Patent Application Publication
(10) Pub. No.: US 2025/0238411 A1
(43) Pub. Date: Jul. 24, 2025

(54) DATABASE INDEX RECOMMENDATION GENERATION BY LARGE LANGUAGE MODEL

(71) Applicant: Microsoft Technology Licensing, LLC, Redmond, WA (US)

(72) Inventors: Antonio Claudio Michejevs PADILHA, Campinas (BR); Ankit MAHAJAN, Sammamish, WA (US); Derek WILSON, Chester, VA (US); Timothy Swift GOODMAN, Bothell, WA (US); Fangzhou HOU, Mill Creek, WA (US); Ya LIN, Bellevue, WA (US); Panagiotis ANTONOPOULOS, Redmond, WA (US); Weiyun HUANG, Bellevue, WA (US); Zhirui YUAN, Sammamish, WA (US)

(21) Appl. No.: 18/417,334

(22) Filed: Jan. 19, 2024

(51) Int. Cl. G06F 16/22; G06F 11/34; G06F 16/21

(52) U.S. Cl. CPC G06F 16/2228; G06F 11/3409; G06F 16/213

(57) ABSTRACT

System, methods, apparatuses, and computer program products are disclosed for using a large language model (LLM) to generate an index recommendation for a database table. A prompt is provided to an LLM to request an index recommendation for a table of a database. The prompt includes index recommendation guidelines and information associated with the table that is determined from one or more sources. An index recommendation is received from the LLM, and an action is performed based on the received index recommendation.

### BACKGROUND

A database index is a data structure that enhances the speed of data retrieval operations on a database table by reducing the time needed to locate particular records. By creating an index, the database engine creates a reference point that assists in optimizing queries, speeding up data retrieval, and/or improving overall system performance.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

System, methods, apparatuses, and computer program products are disclosed for using a large language model (LLM) to generate an index recommendation for a database table. A prompt is provided to an LLM to request an index recommendation for a table of a database. The prompt includes index recommendation guidelines and information associated with the table that is determined from one or more sources. An index recommendation is received from the LLM, and an action is performed based on the received index recommendation.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for recommending an index for a database table using an LLM, in accordance with an embodiment.

FIG. 2 depicts a block diagram of an example system for recommending an index for a database table using an LLM, in accordance with an embodiment.

FIG. 3 depicts a flowchart of a process for recommending an index for a database table using an LLM, in accordance with an embodiment.

FIG. 4 depicts a flowchart of a process for generating a prompt for requesting an index recommendation, in accordance with an embodiment.

FIG. 5 depicts a flowchart of a process for generating a prompt for requesting an index recommendation using a prompt template, in accordance with an embodiment.

FIG. 6 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Large language models or LLMs are advanced artificial intelligence system capable of processing and/or generating human-like text based on vast amounts of training data. These models may be built upon deep neural networks with millions to billions of parameters, enabling them to generate contextually relevant responses to a wide array of queries and prompts. Furthermore, LLMs are developed through extensive training on enormous and diverse datasets, allowing them to comprehend and generate coherent, contextually appropriate text across diverse domains. LLMs excel in natural language processing tasks, such as, but not limited to, text generation, translation, summarization, question-answering, and/or the like.

A database index is a data structure that enhances the speed of data retrieval operations on a database table by reducing the time needed to locate particular records. For instance, a database index may be a copy of selected columns of data, from a table, that is designed to enable very efficient search. Such an index typically includes a “key” or direct link to the original row of data from which it was copied, to allow the complete row to be retrieved efficiently. By creating an index, the database engine creates a reference point that assists in optimizing queries, speeding up data retrieval, and/or improving overall system performance. However, while indexes significantly boost read operations, they can also impact write operations, as data modifications might require updates to the index structure, necessitating a careful balance between read and write performance in database design.

### II. Example Embodiments

Automatic index tuning is a feature provided by database service providers that utilizes algorithms and/or analytics to recommend and/or generate indexes based on query patterns and/or historical usage. By analyzing query execution plans, workload characteristics, and/or access patterns, automatic index tuning identifies potential performance bottlenecks and/or areas where indexing could significantly enhance query speed and recommend creating, modifying, and/or dropping indexes to optimize database performance. Automatic index tuning may be effective for database tables that have sufficient query patterns and/or historical usage upon which make an index recommendation. However, automatic index tuning may struggle to provide useful index recommendations for database tables with little or no historical workload.

During an initial database development phase, database tables may have little or no historical workload information. In such instances, developers with no background in databases cannot rely on automatic index tuning to provide index recommendations, and instead look for solutions by searching available documentation and/or developer forums. However, such solutions may be generic and/or not tailored to the specific scenario faced by the developer. Embodiments disclosed herein are directed to the use of an LLM to provide tailored intelligent index recommendations based on specific scenarios faced by a developer, including, but not limited to, providing index recommendations for newly created database tables and/or existing database tables with little or no historical workload information.

Index recommendation generation may, in embodiments, be automatically initiated based on satisfaction of one or more criteria, such as, but not limited to, detecting the creation of a new database table, detecting a modification of a database and/or table schema, detecting a workload having a high impact on database performance, and/or the like. In embodiments, index recommendation generation may be initiated responsive to a user prompt. For instance, a developer may employ a digital assistance tool, such as, but not limited to, a chatbot, to request an index recommendation for one or more database tables. In embodiments, the developer may request an index recommendation for existing database table(s) by providing the names of the database table(s). In embodiments, the developer may request an index recommendation for a new database table by providing information about the new database table, such as, but not limited to, a schema of the new database table, the relationship between the new database table and one or more existing database tables, and/or a typical query associated with the new database table.

In a first example scenario, a developer may, in embodiments, request an index recommendation for an existing table with the following prompt:
<<ServerName:serverID;DatabaseName:dbID>>
<<TableNames:customer,orders,lineitem>>
Please recommend indexes for the selected tables.
   In this first example scenario, the developer simply identifies one or more tables of the database, and requests an index recommendation for the identified tables. In embodiments, the LLM will generate an index recommendation for the identified tables based on information associated with the tables that may be available in the database, such as, but not limited to, missing index information, schema information, historical workload information, and/or the like. If there is insufficient information associated with the identified tables, the developer may be notified that an index recommendation cannot be provided and/or prompted to provide additional information about the identified tables, such as, but not limited to, typical queries and/or usage of the identified tables.

In a second example scenario, a developer may, in embodiments, request an index recommendation for a newly created table that has little or no historical workload information with the following prompt:
<<ServerName:serverID;DatabaseName:dbID>>
<<TableNames:customer,nation,supplier>>
Please recommend indexes for the selected tables. I need to join both customer and supplier tables with demographics data found in the nation table, and to calculate balances by aggregating the sums of acctbal values by name.
   In this second example scenario, in addition to identifying one or more tables of the database and requesting an index recommendation for the identified tables, the developer provides an example usage of the tables. In embodiments, the LLM will generate an index recommendation for the identified tables based on the information provided by the developer, and/or any information associated with the tables that may be available in the database, such as, but not limited to, missing index information, schema information, historical workload information, and/or the like.

In a third example scenario, a developer may, in embodiments, request an index recommendation before database tables are created with the following prompt:
<<TableNames:planet,moon>>
I need help creating an index from these tables.
The tables will be created using the following script:
create table planet (
   planet_id int not null,
   planet_name varchar(50) not null,
   star_id int,
   period_length float,
   mass float not null);
create table moon (
   moon_id int not null,
   moon_name varchar(50),
   mass_ratio float not null,
   planet_id int,
   period_length float);
A typical query may include:
select
   count (m.*) as number_of_moons,
   p.planet_name
from
   planets p
   inner join moon m on m.planet_id=p.planet_id
   group by p.planet_name
   order by count (m.*)desc
   Please suggest some indexes for both tables.
      In this third example scenario, the developer provides, via a script, a description of the tables and an example of a typical query, and requests index recommendations for the tables. In embodiments, the LLM will generate an index recommendation for the identified tables based on the schema information gleaned from the script provided by the developer and/or the typical query provided by the developer.

Index recommendations may, in embodiments, be generated by providing retrieval-augmented prompts to an LLM. For instance, a user prompt and/or an automatically generated prompt may be augmented with information to aid the LLM to provide a more relevant and/or accurate response. In embodiments, the prompt may be augmented with index recommendations guidelines, and information associated with the database and/or one or more tables therein. In embodiments, information associated with the database table(s) may include, but is not limited to, missing index information, table schema information, workload information, database performance information, query data, and/or the like. Such data may, in embodiments, be automatically retrieved from one or more available sources, such as, but not limited to, management views, system catalog views, dynamic management views (DMVs), system information views, security views, information schema views, and/or the like. In scenarios, database table(s) that have little or no historical workload data may preclude automatic retrieval of information associated with the database table(s). In such instances, the information associated with the database table(s) may be obtained by interacting with the developer through a user interface (UI), such as, but not limited to, a graphical user interface (GUI), chat interface, a command line interface (CLI), a touch-based interface, a voice interface, and/or the like.

A prompt requesting an index recommendation may, in embodiments, be augmented based on the types of the available information associated with the database table(s). For instance, if missing index information is available, the prompt may, in embodiments, include a request to provide an index recommendation based on missing index information, and be augmented with the missing index information and index recommendation guidelines for providing an index recommendation based on missing index information. Furthermore, if table schema information is available, the prompt may, in embodiments, include a request to provide an index recommendation based on table schema information, and be augmented with the table schema information and index recommendation guidelines for providing an index recommendation based on table schema information. Similarly, if workload information is available, the prompt may, in embodiments, include a request to provide an index recommendation based on the workload information, and be augmented with the workload information and index recommendation guidelines for providing an index recommendation based on the workload information. In embodiments, the prompt may be augmented with additional information, such as, but not limited to, current indexes of the database, a typical use case of the database table(s), a typical query, a database metric to be improved, and/or the like. In embodiments, the prompt may request index recommendations for one or more specified database table(s), and/or general index recommendations for the database as a whole. In embodiments, the prompt may request index recommendations for adding an index, modifying an existing index, and/or dropping an existing index.

Index recommendation guidelines may, in embodiments, include information to enable an LLM to recommend a table index based on the information associated with the database table(s). For instance, index recommendation guidelines may include, but are not limited to, indexing strategies, performance considerations, design rationales, platform-specific syntax information, and/or the like. In embodiments, indexing strategies may include column selection criteria that may inform the LLM on which columns to select as an index based on details about the database, such as, but not limited to, the database schema, tables, table schemas, views, columns, data types, constraints (such as primary keys, foreign keys), and/or relationships between tables. In embodiments, performance considerations may include, but are not limited to, information about performance tuning criteria, query optimization techniques, and/or considerations to enhance database efficiency. In embodiments, design rationales may include, but are not limited to, explanations, and/or documentation regarding the reasoning behind various indexing options, trade-offs between the various index options, and/or other considerations. In embodiments, platform-specific syntax information may include, but is not limited to, syntax information for generating one or more database commands for implementing the index recommendations on one or more database platforms. In embodiments, index selection guidelines may be determined from one or more sources, including, but not limited to, one or more preconfigured index selection guidelines developed by a subject matter expert, one or more scenario-based index selection guidelines determined based on the specific scenario encountered, index selection guidelines available from one or more knowledgebases, index selection guidelines available from public sources, index selection guidelines from scientific journals, index selection guidelines from developer forums, and/or the like.

Based on the retrieval-augmented prompt, the LLM may, in embodiments, generate an index recommendation for the database table(s) based on information associated with the database table(s), the index recommendation guidelines, the existing indexes in the database, and/or any additional information. In embodiments, the index recommendation generated by the LLM may include one or more index recommendations, such as, but not limited to, an automatic index recommendation based on missing index information in one or more missing index dynamic management views, an index recommendation based on analysis of schema information, an index recommendation based on query patterns and database performance impacts thereof, and/or any combination thereof. In embodiments, the index recommendation generated by the LLM may include database commands for implementing the index recommendation(s), including, but not limited to, Structured Query Language (SQL) commands, database commands in a platform-specific syntax, hyperlinks to references where the developer may obtain additional information, and/or the like. In embodiments, the index recommendation generated by the LLM may include an explanation for the index recommendation(s) to allow a developer to make an informed decision on which, if any, of the index recommendation(s) to implement. In embodiments, a user may refine the index recommendation(s) provided by the LLM by providing follow-up prompts, such as, but not limited to, prompts including additional information about the database table(s), prompts outlining desired improvements or goals, prompts requesting additional explanations on the index recommendation(s), and/or the like.

Returning to the first example scenario discussed above, if missing index information is available for the identified tables, the LLM may return the following index recommendation:
I can help with creating indexes for your tables. Based on the information
provided, I have the schema for the following tables: customers, orders, and lineitem. I also have an auto-index recommendation for the lineitem table.
For the lineitem table, here is the auto-index recommendation:
CREATE INDEX [idx_lineitem_l_orderkey] ON [dbid . . .
This auto-index recommendation suggests creating a non-clustered index on the lineitem table with the l_orderkey column as the key column and including l_commitdate and l_receiptdate columns. This index can improve query performance when filtering or joining on the l_orderkey column.

### Additional Recommendations:

For the customer table, consider creating indexes on the following columns:
c_custkey(bigint). Reason: likely to be used as a primary key or in joins with other tables.
c_nationkey(int). Reason: if you frequently filter or join on the nation key this may improve performance.

For the orders table, consider creating indexes on the following columns:
o_orderkey(bigint). Reason: likely to be used as a primary key or in joins with other tables.
o_custkey(int). Reason: if you frequently filter or join on the customer key this may improve performance.
For the lineitem table, in addition to the auto-index recommendation above, consider creating indexes on the following columns:
l_partkey(bigint). Reason: if you frequently filter or join on the parts key this may improve performance.
l_suppkey(int). Reason: if you frequently filter or join on the supplier key this may improve performance.
Please note that these additional recommendations are based on static analysis of the table schemas. To provide more refined recommendations, please provide a typical workload, such as example queries with filters and joins that are expected to run on these tables.

Returning to the second example scenario discussed above, the LLM may return the following index recommendation:
I can help with creating indexes for your tables. Based on the information provided, I have the schema for the following tables: customer, nation, and supplier. Based on the schema and your usage requirements, I recommend the following indexes:
For the customer table, create a nonclustered index on the c_nationkey column, as it will be used to join with the nation table. Here is a command to implement the recommendation:
CREATE NONCLUSTERED INDEX idx_customer_c_natio . . .
For the supplier table, create a nonclustered index on the s_nationkey column, as it will be used to join with the nation table. Here is a command to implement the recommendation:
CREATE NONCLUSTERED INDEX idx_supplier_s_natio . . .
For the nation table, create a clustered index on the n_nationkey column, as it is the primary key and will be used for joining with the customer and supplier tables. Here is a command to implement the recommendation:
CREATE CLUSTERED INDEX idx_nation_n_nationkey . . .
These recommended indexes should help the performance of your queries when joining the customer and supplier tables with the nation table to calculate the balance by aggregating the sums of acctbal values.

Returning to the third example scenario discussed above, the LLM may return the following index recommendation:
I can help with creating indexes for your tables. Based on the table schema and example query you provided, I recommend the following indexes for the planet and moon tables:
For the planet table, create a clustered index on the planet_id column, as it is the primary key and is used in the join condition. Here is a command to implement the recommendation:
CREATE CLUSTERED INDEX idx_planet_planet_id ON . . .
For the moon table, create a nonclustered index on the planet_id column, as it is used in the join condition, and include the moon_id column. Here is a command to implement the recommendation:
CREATE NONCLUSTERED INDEX idx_moon_planet_id ON . . .
These indexes should help improve the performance of the example query by optimizing the join operation between the planet and moon tables.

These and further embodiments are disclosed herein that enable the functionality described above and additional functionality. Such embodiments are described in further detail as follows.

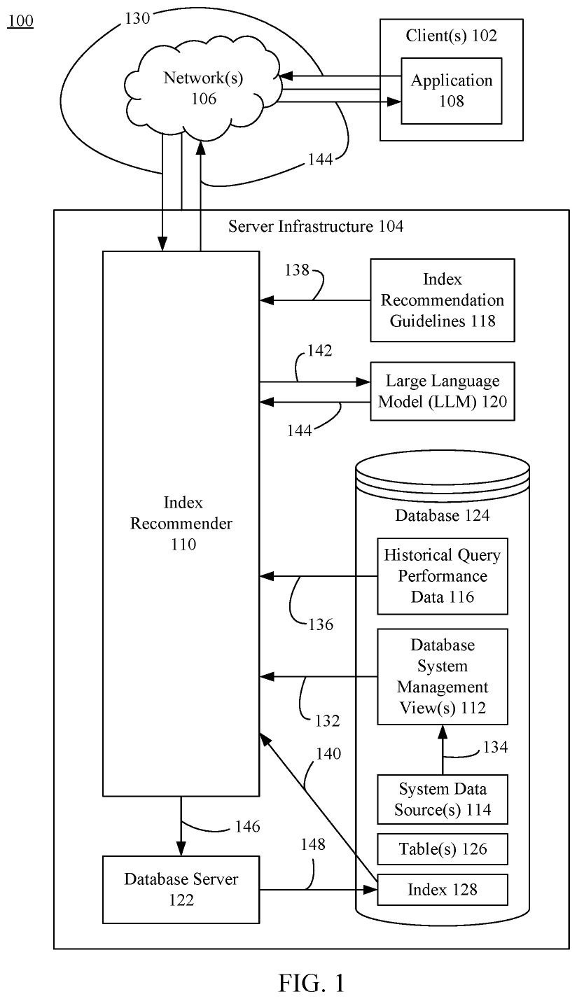

For instance, FIG. 1 shows a block diagram of an example system 100 for recommending an index for a database table using an LLM, in accordance with an embodiment. As shown in FIG. 1, system 100 includes one or more clients 102 and a server infrastructure 104, which are communicatively coupled to each other via one or more networks 106. Furthermore, one or more of client(s) 102 includes an application 108, and server infrastructure 104 includes an index recommender 110, index recommendation guidelines 118, an LLM 120, a database server 122, and a database 124. Moreover, database 124 further includes one or more database system management views 112, one or more system data sources 114, historical query performance data 116, one or more tables 126, and an index 128. System 100 is described in further detail as follows.

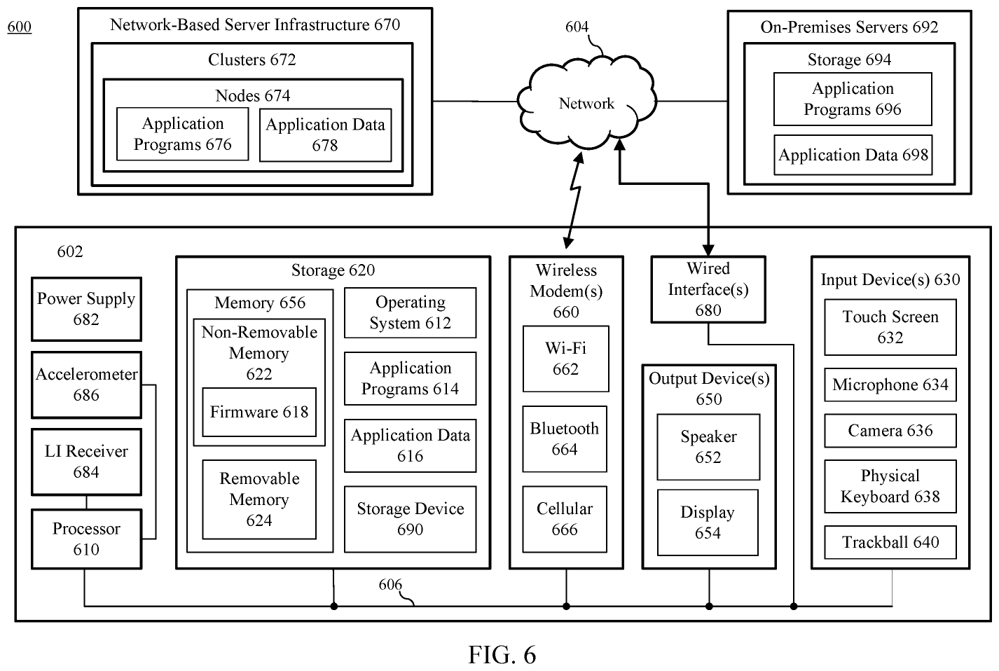

Each of client(s) 102 may comprise any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. As shown in FIG. 1, each of client(s) 102 includes an application 108 that can transmit to server infrastructure 104 one or more requests 130 for one or more index recommendations 144. Various example implementations of client(s) 102 are described below in reference to FIG. 6 (e.g., computing device 602, and/or components thereof).

In embodiments, application 108 may comprise various applications, such as, but not limited to, mobile applications, desktop applications, a web browser, and/or the like, configured to generate request(s) 130 for requesting index recommendation(s) 144. Various example implementations of application 108 are described below in reference to FIG. 6 (e.g., application 614, and/or components thereof).

Server infrastructure 104 may be a network-accessible server set (e.g., a cloud-based environment or platform). In an embodiment, the underlying resources of server infrastructure 104 may be co-located (e.g., housed in one or more nearby buildings with associated components such as backup power supplies, redundant data communications, environmental controls, etc.) to form a datacenter, may be distributed across different regions, and/or may be arranged in other manners. Various example implementations of server infrastructure 104 are described below in reference to FIG. 6 (e.g., network-based server infrastructure 670, and/or components thereof).

Network(s) 106 may comprise one or more networks such as local area networks (LANs), wide area networks (WANs), enterprise networks, the Internet, etc., and may include one or more wired and/or wireless portions. Various example implementations of network(s) 106 are described below in reference to FIG. 6 (e.g., network 604, and/or components thereof).

Index recommender 110 may be configured to receive one or more index recommendation requests (e.g., request(s) 130) requesting index recommendation(s) 144 for table(s) 126, retrieve information associated with table(s) 126, and provide, to LLM 120, a retrieval-augmented prompt 142 that is generated based on the retrieved information. In embodiments, index recommender 110 may retrieve one or more of: database system management view information 132, such as, but not limited to, missing index information and/or schema information from database system management view(s) 112, impactful workload information 136 from historical query performance data 116, relevant index recommendation guidelines 138 from index recommendation guidelines 118, and/or current indexes 140 from index 128. In embodiments, index recommender 110 may prompt a user of client(s) 102 for information associated with table(s) 126. For instance, index recommender 110 may determine that there is insufficient information about table(s) 126 to provide useful index recommendation(s) 144, and may interact with a user of client(s) 102 to obtain additional information about table(s) 126. Index recommender 110 may be configured to receive, from LLM 120, index recommendation(s) 144, and perform an action, such as, but not limited to, providing one or more commands 146 to database server 122 to add, modify, and/or dropping one or more indexes 148 in index 128, and/or providing index recommendation(s) 144 to client(s) 102.

Database system management view(s) 112 may include constructs that provide access to metadata and/or information about the database 124. In embodiments, database system management view(s) 112 may include, but are not limited to, system catalog views, DMVs, system information views, security views, and/or the like. In embodiments, DMVs are virtual tables that expose information about the database system's state and/or performance based on underlying data 134 obtained from system data source(s) 114. In embodiments, DMVs may include, but are not limited to, a DMV that includes missing index information and/or a DMV that includes schema information. Database system management view(s) 112 may provide database system management view information 132 to index recommender 110.

System data source(s) 114 may include internal system structures, memory-resident tables, and/or performance counters maintained by a database engine. For instance, system data source(s) 114 may include, but are not limited to, system catalogs containing metadata about database objects and their properties, memory-resident structures that provide real-time data about ongoing operations and resource utilization, and/or performance counters related to the utilization of system resources, query execution statistics, memory usage, disk I/O, CPU consumption, and/or the like. In embodiments, database system management view(s) 112 may include information obtained from system data source(s) 114.

Historical query performance data 116 may be configured to store query execution details and/or performance metrics. In embodiments, historical query performance data 116 may store historical information about query plans, runtime statistics, and/or execution history. In embodiments, historical query performance data 116 provides, to index recommender 110, impactful workload information 136 to enable index recommender 110 to determine impactful queries affecting the performance of database 124.

Index recommendation guidelines 118 may include information to enable an LLM to recommend a table index based on the information associated with the database table(s). For instance, index recommendation guidelines 118 may include, but are not limited to, indexing strategies, performance considerations, design rationales, platform-specific syntax information, and/or the like. In embodiments, index recommendation guidelines may be source from one or more data sources, such as, but not limited to, knowledgebases, technical documentation, developer forums, research databases, public data sources, private data sources, and/or the Internet. In embodiments, index recommendation guidelines 118 may provide, to index recommender 110, relevant index recommendation guidelines 138 that may be relevant to the index recommendation request(s) (e.g., request(s) 130). For instance, relevant index recommendation guidelines 138 may include portions of index recommendation guidelines 118 determined based on an analysis of the index recommendation request(s) (e.g., request(s) 130), and/or the retrieved information associated with table(s) 126. In embodiments, relevant index recommendation guidelines 138 may include a portion and/or all of index recommendation guidelines 118.

LLM 120 may include a machine learning model trained on enormous and diverse datasets using deep learning algorithms, and is configured to perform natural language processing tasks, such as, but not limited to, text generation, translation, summarization, question-answering, and/or the like. In embodiments, LLM 120 may include, but is not limited to, publicly available LLMs, private or internal LLMs, general knowledge LLMs, domain specific LLMs, and/or the like. LLM 120 is configured to receive retrieval-augmented prompt 142 from index recommender 110, and provide, to index recommender 110, index recommendation(s) 144.

In embodiments, index recommendation(s) 144 may include one or more index recommendations, such as, but not limited to, an automatic index recommendation based on missing index information in one or more missing index dynamic management views, an index recommendation based on analysis of schema information, an index recommendation based on query patterns and database performance impacts thereof, and/or any combination thereof. In embodiments, index recommendation(s) 144 may include database commands for implementing the index recommendation(s), including, but not limited to, SQL commands, database commands in a platform-specific syntax, and/or the like. In embodiments, index recommendation(s) 144 may include an explanation for index recommendation(s) 144 to allow a developer to make an informed decision on which, if any, of index recommendation(s) 144 to implement. In embodiments, index recommendation(s) 144 may include hyperlinks to additional reference material, such as, but not limited to, user guides, knowledgebases, developer forums, and/or the like.

Database server 122 may include one or more physical and/or virtual servers that store, manage, and/or provide access to database 124. In embodiments, database server 122 may be configured to perform tasks, such as, but not limited to, processing SQL queries, managing transactions, enforcing access controls, optimizing database 124, and/or the like. Database server 122 may, in embodiments, receive command(s) 146 from index recommender 110, and process command(s) 146 by adding, modifying, and/or dropping index (cs) 148 in index 128.

Database 124 may include a structured and organized collection of data stored in table(s) 126 that may, in embodiments, be interconnected through defined relationships. In database 124, table(s) 126 may store data in rows and columns, and keys may be used to establish the relationships between table(s) 126. In embodiments, table(s) 126 may each represent an entity, and columns within table(s) 126 may define attributes or properties of the entities. In embodiments, database 124 may include, in index 128, one or more indexes that store sorted references to specific data within table(s) 126 to enhance access to information stored in table(s) 126. In embodiments, indexes of index 128 are created on columns or combinations of columns of table(s) 126 to allow database server 122 to quickly locate and retrieve information from table(s) 126 based on the indexed columns.

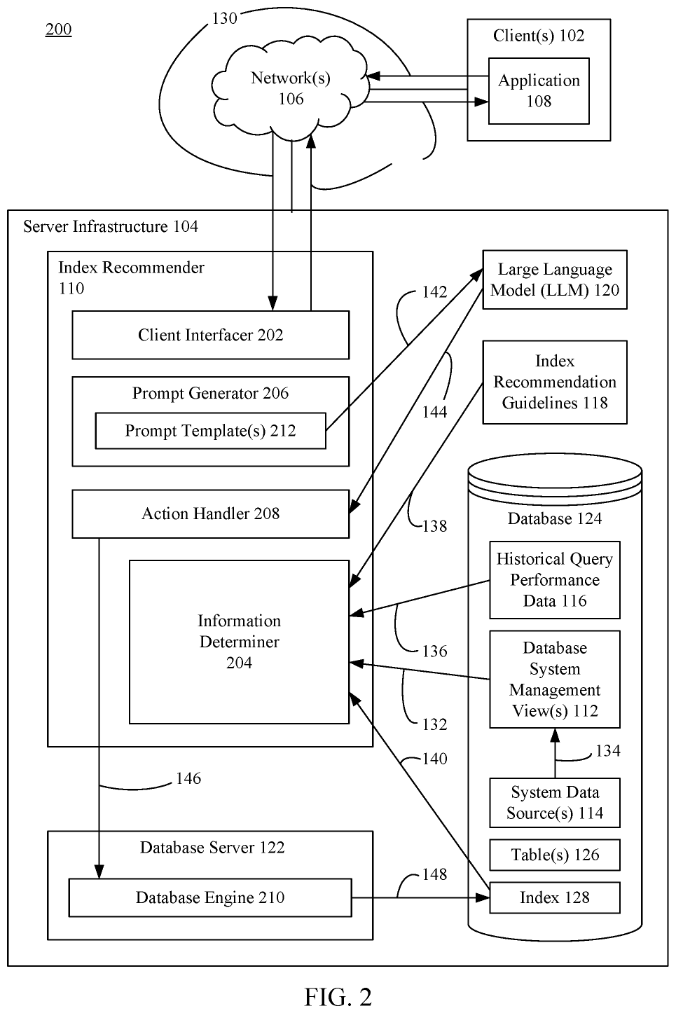

Embodiments described herein may operate in various ways to recommend an index for a database table using an LLM. For instance, FIG. 2 shows a block diagram of an example system 200 for recommending an index for a database table using an LLM, in accordance with an embodiment. As shown in FIG. 2, system 200 includes client(s) 102, server infrastructure 104, index recommender 110, database system management view(s) 112, system data source(s) 114, historical query performance data 116, index recommendation guidelines 118, and LLM 120, database server 122, database 124, table(s) 126, and index 128. In system 200, index recommender 110 further includes a client interfacer 202, an information determiner 204, a prompt generator 206, and an action handler 208. Furthermore, database server 122 includes a database engine 210, and prompt generator 206 includes one or more prompt templates 212. System 200 is described in further detail as follows.

Client interfacer 202 is configured to communicate with client(s) 102 over network(s) 106. For instance, client interfacer 202 may receive request(s) 130 from client(s) 102, and/or provide index recommendation(s) 144 to client(s) 102. In embodiments, client interfacer 202 may communicate with a user of client(s) 102 to obtain additional information about table(s) 126 in order to provide index recommendation(s) 144. For instance, client interfacer 202 may, in embodiments, provide, via application 108, a user interface to allow a user of client(s) 102 to interact with index recommender 110. In embodiments, the user interface may include, but is not limited to, a GUI, a chat interface, a CLI, a touch-based interface, a voice interface, and/or the like. For instance, client interfacer 202 may, in embodiments, include a natural language processing (NLP) model to process natural language prompts from the user and/or to generate natural language responses for the user.

Information determiner 204 is configured to determine information associated with table(s) 126 from various sources, such as, but not limited to, request(s) 130, database system management view(s) 112, historical query performance data 116, index recommendation guidelines 118, and/or index 128. For instance, information determiner 204 may retrieve database system management view information 132, such as, but not limited to, missing index information and/or schema information from database system management view(s) 112, impactful workload information 136 from historical query performance data 116, relevant index recommendation guidelines 138 from index recommendation guidelines 118, and/or current indexes 140 from index 128. In embodiments, information determiner 204 may determine that additional information may be necessary to provide a useful index recommendation, and may, in embodiments, cause client interfacer 202 to prompt a user of client(s) 102 for information associated with table(s) 126. In embodiments, information determiner 204 may provide the information associated with table(s) 126 to prompt generator 206 to allow prompt generator 206 to generate retrieval-augmented prompt 142.

Prompt generator 206 is configured to generate retrieval-augmented prompt 142 based on information associated with table(s) 126, and provide retrieval-augmented prompt 142 to LLM 120 to request index recommendation(s) 144. In embodiments, prompt generator 206 may employ prompt template(s) 212 to generate retrieval-augmented prompt 142. In embodiments, prompt template(s) 212 may include one or more prompt templates for use in one or more index recommendation scenarios. For instance, prompt generator 206 may select, based on the types of available information associated with table(s) 126, one or more prompt template(s) 212 for use in generating retrieval-augmented prompt 142. In embodiments, prompt generator 206 may include instructions for LLM 120 based on the index recommendation scenario. For instance, prompt generator 206 may include, in retrieval-augmented prompt 142, instructions requesting an automated index recommendation if missing index information is included in retrieval-augmented prompt 142, instructions requesting a static index recommendation based on static analysis of schema information if schema information is included in retrieval-augmented prompt 142, and/or instructions requesting a workload-based index recommendation if impactful workload information is included in retrieval-augmented prompt 142.

Prompt template(s) 212 may, in embodiments, include one or more static textual components, and/or one or more placeholder components that are each associated with an information type. For instance, prompt template(s) 212 may, in embodiments, include placeholders for one or more of: missing index information, schema information, impactful workload information, typical query information, index recommendation guideline information, and/or the like. In embodiments, prompt generator 206 may generate retrieval-augmented prompt 142 by replacing one or more placeholders in prompt template(s) 212 with information about table(s) 126 having an information type associated with the placeholders. For instance, prompt generator 206 may replace a placeholder for missing index information with missing index information retrieved from database system management view(s) 112, replace a placeholder for schema information with schema information retrieved from database system management view(s) 112, replace a placeholder for impactful workload information with impactful workload information 136 retrieved from historical query performance data 116, replace a placeholder for index recommendation guidelines with relevant index recommendation guidelines 138 retrieved from index recommendation guidelines 118, and/or replace a placeholder for current indexes with current indexes 140 retrieved from index 128. In embodiments, relevant index recommendation guidelines 138 may be incorporated as static textual components in prompt template(s) 212.

Action handler 208 is configured to receive, from LLM 120, index recommendation(s) 144, and perform an action based on index recommendation(s) 144. For instance, action handler 208 may, in embodiments, provide index recommendation(s) 144 to client(s) 102 for output via application 108. In embodiments, action handler 208 may generate and/or provide command(s) 146 to database engine 210 of database server 122 in order to cause database engine 210 to add, modify, and/or drop index(es) 148 in index 128.

Database engine 210 is configured to receive command(s) 146 from action handler 208, and process command(s) 146 by adding, modifying, and/or dropping index(es) 148 in index 128. In embodiments, database engine 210 may be configured to perform other functions, including, but not limited to, processing queries, executing commands, ensuring data integrity, optimizing storage and retrieval processes, managing transactions, carrying out concurrency control, implementing query optimizations and/or the like.

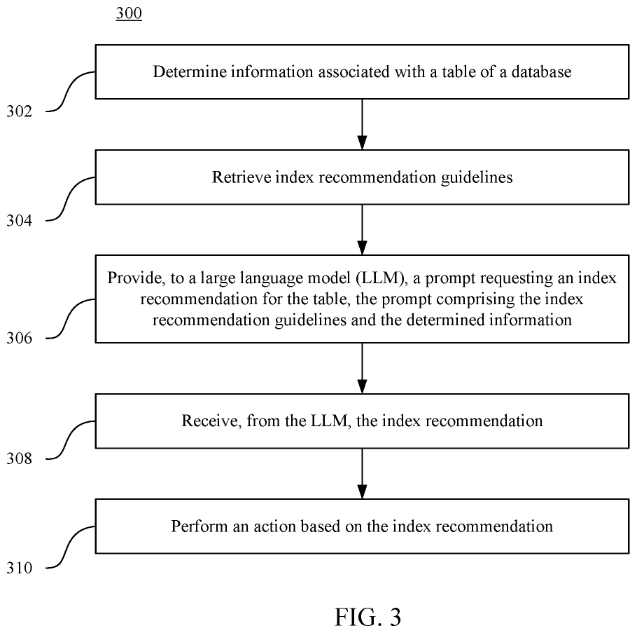

Embodiments described herein may operate in various ways to recommend an index for a table using an LLM. For instance, FIG. 3 depicts a flowchart 300 of a process for recommending an index for a database table using an LLM, in accordance with an embodiment. In embodiments, server infrastructure 104, index recommender 110, database server 122, client interfacer 202, information determiner 204, prompt generator 206, action handler 208, database engine 210, and/or prompt template(s) 212 of FIGS. 1-2 may operate according to flowchart 300, for example. Note that not all steps of flowchart 300 may need to be performed in all embodiments, and in some embodiments, the steps of flowchart 300 may be performed in different orders than shown. Flowchart 300 is described as follows with respect to FIGS. 1-2 for illustrative purposes.

Flowchart 300 starts at step 302. In step 302, information associated with a table of a database is determined. For example, information determiner 204 may determine information associated with table(s) 126 of database 124. In embodiments, information determiner 204 may determine information associated with table(s) 126 from various sources, such as, but not limited to, request(s) 130, database system management view(s) 112, historical query performance data 116, and/or index 128. For instance, information determiner 204 may retrieve database system management view information 132, such as, but not limited to, missing index information and/or schema information from database system management view(s) 112, impactful workload information 136 from historical query performance data 116, and/or current indexes 140 from index 128. In embodiments, information determiner 204 may determine information associated with table(s) 126 by causing client interfacer 202 to prompt a user of client(s) 102 for additional information about table(s) 126.

In step 304, index recommendation guidelines are retrieved. For example, information determiner 204 may retrieve relevant index recommendation guidelines 138 from index recommendation guidelines 118. In embodiments, relevant index recommendation guidelines 138 may include portions of index recommendation guidelines 118 determined based on an analysis of the index recommendation request(s) (e.g., request(s) 130), and/or the retrieved information associated with table(s) 126. In embodiments, relevant index recommendation guidelines 138 may include a portion and/or all of index recommendation guidelines 118. In embodiments, information determiner 204 may retrieve relevant index recommendation guidelines 138 prior to the arrival of request(s) 130 and/or incorporate relevant index recommendation guidelines 138 into prompt template(s) 212 as static textual components.

In step 306, a prompt requesting an index recommendation for the table is provided to an LLM, the prompt comprising the index recommendation guidelines and the determined information. For example, prompt generator 206 may provide, to LLM 120, retrieval-augmented prompt 142 to request, from LLM 120, index recommendation(s) 144 for table(s) 126. In embodiments, prompt generator 206 may employ prompt template(s) 212 to generate retrieval-augmented prompt 142 by replacing one or more placeholders in prompt template(s) 212 with information about table(s) 126 having an information type associated with the placeholders.

In step 308, the index recommendation is received from the LLM. For example, action handler 208 may receive index recommendation(s) 144 from LLM 120. In embodiments, index recommendation(s) 144 may include one or more index recommendations, such as, but not limited to, an automatic index recommendation based on missing index information in one or more missing index dynamic management views, an index recommendation based on analysis of schema information, an index recommendation based on query patterns and database performance impacts thereof, and/or any combination thereof. In embodiments, index recommendation(s) 144 may include database commands for implementing the index recommendation(s), including, but not limited to, SQL commands, database commands in a platform-specific syntax, and/or the like. In embodiments, index recommendation(s) 144 may include an explanation for index recommendation(s) 144 to allow a developer to make an informed decision on which, if any, of index recommendation(s) 144 to implement.

In step 310, an action is performed based on the index recommendation. For example, action handler 208 may perform an action based on index recommendation(s) 144. For instance, action handler 208 may, in embodiments, provide index recommendation(s) 144 to client(s) 102 for output via application 108. In embodiments, action handler 208 may generate and/or provide command(s) 146 to database engine 210 of database server 122 in order to cause database engine 210 to add, modify, and/or drop index (cs) 148 in index 128.

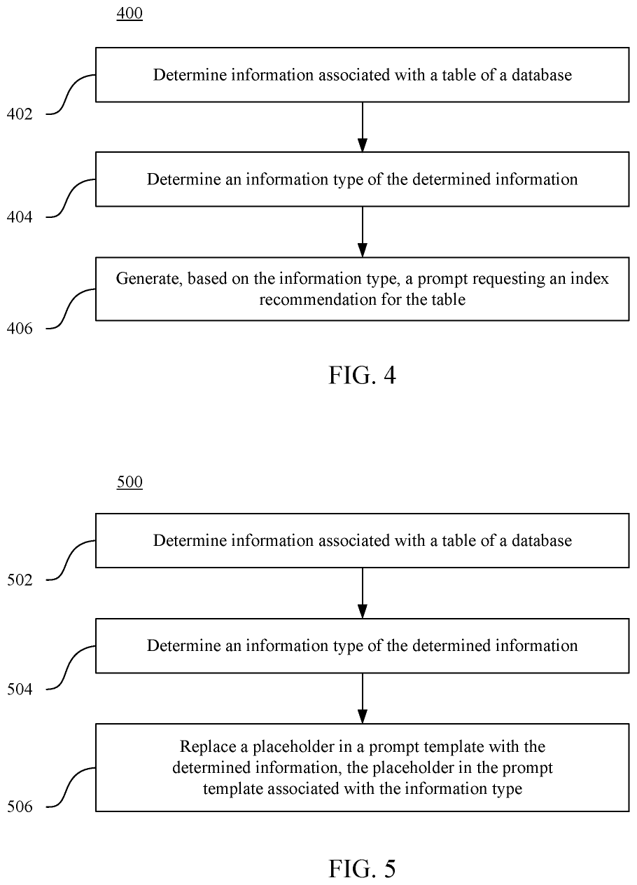

Embodiments described herein may operate in various ways to generate a prompt for requesting an index recommendation. For instance, FIG. 4 depicts a flowchart 400 of a process for generating a prompt for requesting an index recommendation, in accordance with an embodiment In embodiments, server infrastructure 104, index recommender 110, database server 122, client interfacer 202, information determiner 204, prompt generator 206, action handler 208, database engine 210, and/or prompt template 212 of FIGS. 1-2 may operate according to flowchart 400, for example. Note that not all steps of flowchart 400 may need to be performed in all embodiments, and in some embodiments, the steps of flowchart 400 may be performed in different orders than shown. Flowchart 400 is described as follows with respect to FIGS. 1-2 for illustrative purposes.

Flowchart 400 starts at step 402. In step 402, information associated with a table of a database is determined. For example, information determiner 204 may determine information associated with table(s) 126 of database 124. In embodiments, information determiner 204 may determine information associated with table(s) 126 from various sources, such as, but not limited to, request(s) 130, database system management view(s) 112, historical query performance data 116, and/or index 128. For instance, information determiner 204 may retrieve database system management view information 132, such as, but not limited to, missing index information and/or schema information from database system management view(s) 112, impactful workload information 136 from historical query performance data 116, and/or current indexes 140 from index 128. In embodiments, information determiner 204 may determine information associated with table(s) 126 by causing client interfacer 202 to prompt a user of client(s) 102 for additional information about table(s) 126.

In step 404, an information type is determined for the determined information. For example, prompt generator 206 may determine an information type for the determined information associated with table(s) 126. In embodiments, prompt generator 206 may determine the information type based on the source of the determined information associated with table(s) 126. For instance, information retrieved from one or more missing index dynamic management views may be determined as missing index information, information retrieved from a schema DMV may be determined as schema information, and/or information retrieved from historical query performance data 116 may be determined as impactful workload information. In embodiments, prompt generator 206 may determine the information type based on NLP analysis of the determined information. For instance, information provided by a user of client(s) 102 may be analyzed to determine the context of the information, and the information type may be determined based on the context.

In step 406, a prompt requesting an index recommendation for the table is generated based on the information type. For example, prompt generator 206 may generate retrieval-augmented prompt 142 by replacing one or more placeholders in prompt template(s) 212 with information about table(s) 126 having an information type associated with the placeholders. In embodiments, prompt generator 206 may replace a placeholder for missing index information with missing index information retrieved from database system management view(s) 112, replace a placeholder for schema information with schema information retrieved from database system management view(s) 112, replace a placeholder for impactful workload information with impactful workload information 136 retrieved from historical query performance data 116, and/or replace a placeholder for current indexes with current indexes 140 retrieved from index 128.

Embodiments described herein may operate in various ways to generate a prompt for requesting an index recommendation using a prompt template. For instance, FIG. 5 depicts a flowchart 500 of a process for generating a prompt for requesting an index recommendation using a prompt template, in accordance with an embodiment In embodiments, server infrastructure 104, index recommender 110, database server 122, client interfacer 202, information determiner 204, prompt generator 206, action handler 208, database engine 210, and/or prompt template(s) 212 of FIGS. 1-2 may operate according to flowchart 500 may need to be performed in all embodiments, and in some embodiments, the steps of flowchart 500 may be performed in different orders than shown. Flowchart 500 is described as follows with respect to FIGS. 1-2 for illustrative purposes.

Flowchart 500 starts at step 502. In step 502, information associated with a table of a database is determined. For example, information determiner 204 may determine information associated with table(s) 126 of database 124. In embodiments, information determiner 204 may determine information associated with table(s) 126 from various sources, such as, but not limited to, request(s) 130, database system management view(s) 112, historical query performance data 116, and/or index 128. For instance, information determiner 204 may retrieve database system management view information 132, such as, but not limited to, missing index information and/or schema information from database system management view(s) 112, impactful workload information 136 from historical query performance data 116, and/or current indexes 140 from index 128. In embodiments, information determiner 204 may determine information associated with table(s) 126 by causing client interfacer 202 to prompt a user of client(s) 102 for additional information about table(s) 126.

In step 504, an information type is determined for the determined information. In embodiments, prompt generator 206 may determine the information type based on the source of the determined information associated with table(s) 126. For instance, information retrieved from missing index dynamic management view(s) may be determined as missing index information, information retrieved from a schema DMV may be determined as schema information, and/or information retrieved from historical query performance data 116 may be determined as impactful workload information. In embodiments, prompt generator 206 may determine the information type based on NLP analysis of the determined information. For instance, information provided by a user of client(s) 102 may be analyzed to determine the context of the information, and the information type may be determined based on the context.

In step 506, a placeholder in a prompt template is replaced with the determined information, the placeholder in the prompt template associated with the information type. For example, prompt generator 206 may generate retrieval-augmented prompt 142 by replacing one or more placeholders in prompt template(s) 212 with information about table(s) 126 having an information type associated with the placeholders. In embodiments, prompt generator 206 may replace a placeholder for missing index information with missing index information retrieved from database system management view(s) 112, replace a placeholder for schema information with schema information retrieved from database system management view(s) 112, replace a placeholder for impactful workload information with impactful workload information 136 retrieved from historical query performance data 116, and/or replace a placeholder for current indexes with current indexes 140 retrieved from index 128.

### III. Example Mobile Device and Computer System Implementation

The systems and methods described above in reference to FIGS. 1-5, including client(s) 102, server infrastructure 104, network(s) 106, application 108, server infrastructure 104, index recommender 110, database system management view(s) 112, system data source(s) 114, historical query performance data 116, index recommendation guidelines 118, LLM 120, database server 122, database 124, table(s) 126, index 128, client interfacer 202, information determiner 204, prompt generator 206, action handler 208, database engine 210, prompt template(s) 212, and/or each of the components described therein, and/or the steps of flowcharts 300, 400 and/or 500 may be implemented in hardware, or hardware combined with one or both of software and/or firmware. For example, client(s) 102, server infrastructure 104, network(s) 106, application 108, server infrastructure 104, index recommender 110, database system management view(s) 112, system data source(s) 114, historical query performance data 116, index recommendation guidelines 118, LLM 120, database server 122, database 124, table(s) 126, index 128, client interfacer 202, information determiner 204, prompt generator 206, action handler 208, database engine 210, prompt template(s) 212, and/or each of the components described therein, and/or the steps of flowcharts 300, 400 and/or 500 may be each implemented as computer program code/instructions configured to be executed in one or more processors and stored in a computer readable storage medium. Alternatively, client(s) 102, server infrastructure 104, network(s) 106, application 108, server infrastructure 104, index recommender 110, database system management view(s) 112, system data source(s) 114, historical query performance data 116, index recommendation guidelines 118, LLM 120, database server 122, database 124, table(s) 126, index 128, client interfacer 202, information determiner 204, prompt generator 206, action handler 208, database engine 210, prompt template(s) 212, and/or each of the components described therein, and/or the steps of flowcharts 300, 400 and/or 500 may be each implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 6. FIG. 6 shows a block diagram of an exemplary computing environment 600 that includes a computing device 602. Computing device 602 is an example of client(s) 102 shown in FIGS. 1 and 2, which may each include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc., and may include one or more wired and/or wireless portions. Network 604 may additionally or alternatively include a cellular network for cellular communications. Computing device 602 is described in detail as follows.

Computing device 602 can be any of a variety of types of computing devices. For example, computing device 602 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. Computing device 602 may alternatively be a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 690. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and any combination of the components may be present in a particular embodiment. These components of computing device 602 are described as follows.

A single processor 610 (e.g., central processing unit (CPU), microcontroller, a microprocessor, signal processor, ASIC (application specific integrated circuit), and/or other physical hardware processor circuit) or multiple processors 610 may be present in computing device 602 for performing such tasks as program execution, signal coding, data processing, input/output processing, power control, and/or other functions. Processor 610 may be a single-core or multi-core processor, and each processor core may be single-threaded or multithreaded (to provide multiple threads of execution concurrently). Processor 610 is configured to execute program code stored in a computer readable medium, such as program code of operating system 612 and application programs 614 stored in storage 620. The program code is structured to cause processor 610 to perform operations, including the processes/methods disclosed herein. Operating system 612 controls the allocation and usage of the components of computing device 602 and provides support for one or more application programs 614 (also referred to as “applications” or “apps”). Application programs 614 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 610 may include one or more general processors (e.g., CPUs) configured with or coupled to one or more hardware accelerators, such as one or more NPUs and/or one or more GPUs.

Any component in computing device 602 can communicate with any other component according to function, although not all connections are shown for case of illustration. For instance, as shown in FIG. 6, bus 606 is a multiple signal line communication medium (e.g., conductive traces in silicon, metal traces along a motherboard, wires, etc.) that may be present to communicatively couple processor 610 to various other components of computing device 602, although in other embodiments, an alternative bus, further buses, and/or one or more individual signal lines may be present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 690, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 622 may include main memory and may be separate from or fabricated in a same integrated circuit as processor 610. As shown in FIG. 6, non-removable memory 622 stores firmware 618, which may be present to provide low-level control of hardware. Examples of firmware 618 include BIOS (Basic Input/Output System, such as on personal computers) and boot firmware (e.g., on smart phones). Removable memory 624 may be inserted into a receptacle of or otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 690 may be present that are internal and/or external to a housing of computing device 602 and may or may not be removable. Examples of storage device 690 include a hard disk drive, a SSD, a thumb drive (e.g., a USB (Universal Serial Bus) flash drive), or other physical storage device.

One or more programs may be stored in storage 620. Such programs include operating system 612, one or more application programs 614, and other program modules and program data. Examples of such application programs may include, for example, computer program logic (e.g., computer program code/instructions) for implementing client(s) 102, server infrastructure 104, network(s) 106, application 108, server infrastructure 104, index recommender 110, database system management view(s) 112, system data source(s) 114, historical query performance data 116, index recommendation guidelines 118, LLM 120, database server 122, database 124, table(s) 126, index 128, client interfacer 202, information determiner 204, prompt generator 206, action handler 208, database engine 210, prompt template(s) 212, and/or each of the components described therein, as well as any of flowcharts 300, 400, 500, and/or any individual steps thereof.

Storage 620 also stores data used and/or generated by operating system 612 and application programs 614 as application data 616. Examples of application data 616 include web pages, text, images, tables, sound files, video data, and other data, which may also be sent to and/or received from one or more network servers or other devices via one or more wired or wireless networks. Storage 620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 602 through one or more input devices 630 and may receive information from computing device 602 through one or more output devices 650. Input device(s) 630 may include one or more of touch screen 632, microphone 634, camera 636, physical keyboard 638 and/or trackball 640 and output device(s) 650 may include one or more of speaker 652 and display 654. Each of input device(s) 630 and output device(s) 650 may be integral to computing device 602 (e.g., built into a housing of computing device 602) or external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 may display information, as well as operating as touch screen 632 by receiving user commands and/or other information (e.g., by touch, finger gestures, virtual keyboard, etc.) as a user interface. Any number of each type of input device(s) 630 and output device(s) 650 may be present, including multiple microphones 634, multiple cameras 636, multiple speakers 652, and/or multiple displays 654.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). Wireless modem 660 may also or alternatively include other radio-based modem types, such as a Bluetooth modem 664 (also referred to as a “Bluetooth device”) and/or Wi-Fi modem 662 (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 664 is configured to communicate with another Bluetooth-capable device according to the Bluetooth short-range wireless technology standard(s) such as IEEE 802.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and may receive power from a battery internal to computing device 602, and/or from a power cord plugged into a power port of computing device 602 (e.g., a USB port, an A/C power port). LI receiver 684 may be used for location determination of computing device 602 and may include a satellite navigation receiver such as a Global Positioning System (GPS) receiver or may include other type of location determiner configured to determine location of computing device 602 based on received information (e.g., using cell tower triangulation, etc.). Accelerometer 686 may be present to determine an orientation of computing device 602.

Note that the illustrated components of computing device 602 are not required or all-inclusive, and fewer or greater numbers of components may be present as would be recognized by one skilled in the art. For example, computing device 602 may also include one or more of a gyroscope, barometer, proximity sensor, ambient light sensor, digital compass, etc. Processor 610 and memory 656 may be co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein may be stored in storage 620 and executed by processor 610.

In some embodiments, server infrastructure 670 may be present in computing environment 600 and may be communicatively coupled with computing device 602 via network 604. Server infrastructure 670, when present, may be a network-accessible server set (e.g., a cloud-based environment or platform). As shown in FIG. 6, server infrastructure 670 includes clusters 672. Each of clusters 672 may comprise a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. Any of nodes 674 may be a storage node that comprises a plurality of physical storage disks, SSDs, and/or other physical storage devices that are accessible via network 604 and are configured to store data associated with the applications and services managed by nodes 674. For example, as shown in FIG. 6, nodes 674 may store application data 678.

Each of nodes 674 may, as a compute node, comprise one or more server computers, server systems, and/or computing devices. For instance, a node 674 may include one or more of the components of computing device 602 disclosed herein. Each of nodes 674 may be configured to execute one or more software applications (or “applications”) and/or services and/or manage hardware resources (e.g., processors, memory, etc.), which may be utilized by users (e.g., customers) of the network-accessible server set. For example, as shown in FIG. 6, nodes 674 may operate application programs 676. In an implementation, a node of nodes 674 may operate or comprise one or more virtual machines, with each virtual machine emulating a system architecture (e.g., an operating system), in an isolated manner, upon which applications such as application programs 676 may be executed.

In an embodiment, one or more of clusters 672 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 672 may be a datacenter in a distributed collection of datacenters. In embodiments, exemplary computing environment 600 comprises part of a cloud-based platform.

In an embodiment, computing device 602 may access application programs 676 for execution in any manner, such as by a client application and/or a browser at computing device 602.

For purposes of network (e.g., cloud) backup and data security, computing device 602 may additionally and/or alternatively synchronize copies of application programs 614 and/or application data 616 to be stored at network-based server infrastructure 670 as application programs 676 and/or application data 678. For instance, operating system 612 and/or application programs 614 may include a file hosting service client configured to synchronize applications and/or data stored in storage 620 at network-based server infrastructure 670.

In some embodiments, on-premises servers 692 may be present in computing environment 600 and may be communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 may be shared by on-premises servers 692 between computing devices of the organization, including computing device 602 (when part of an organization) through a local network of the organization, and/or through further networks accessible to the organization (including the Internet). Furthermore, on-premises servers 692 may serve applications such as application programs 696 to the computing devices of the organization, including computing device 602. Accordingly, on-premises servers 692 may include storage 694 (which includes one or more physical storage devices such as storage disks and/or SSDs) for storage of application programs 696 and application data 698 and may include one or more processors for execution of application programs 696. Still further, computing device 602 may be configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 may be used to implement systems, clients, or devices, or components/subcomponents thereof, disclosed elsewhere herein. In other embodiments, a combination of computing device 602, network-based server infrastructure 670, and/or on-premises servers 692 may be used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 614) may be stored in storage 620. Such computer programs may also be received via wired interface(s) 680 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### IV. Additional Example Embodiments

In an embodiment, a method comprises: determining information associated with a table of a database; retrieving index recommendation guidelines; providing, to a large language model (LLM), a prompt requesting an index recommendation for the table, the prompt comprising the index recommendation guidelines and the determined information; receiving, from the LLM, the index recommendation; and performing an action based on the index recommendation.

In an embodiment, performing an action comprises at least one of: providing the index recommendation to a user; providing, to the user, a reason for the index recommendation, the reason generated by the LLM based at least on the index recommendation guidelines; or automatically implementing the index recommendation by creating an index for the table based on the index recommendation.

In an embodiment, determining information associated with the table comprises at least one of: retrieving missing index information from a missing index dynamic management view; retrieving a schema of the table from a first management view associated with the database; receiving the schema of the table from a user; retrieving impactful workload information from a second management view associated with the database, the impactful workload information comprises a query statement associated with a query with a high impact on database performance; retrieving impactful workload information from a query data store associated with the database, the query data store comprising historical query information and performance information; or receiving, from the user, impactful workload information, the impactful workload information comprising a query statement representative of an impactful workload.

In an embodiment, the index recommendation comprises at least one of: a ranked list of missing indexes determined based on the missing index information, the ranked list ranked in decreasing order of expected improvement of query performance associated with the table; a first recommended index for the table determined based on analysis of the schema of the table; a second recommended index for the table determined based on analysis of the impactful workload information; or a third recommended index for the table determined based on analysis of the schema of the table and the impactful workload information.

In an embodiment, the method further comprises: determining an information type of the determined information; and generating the prompt based on the information type of the determined information.

In an embodiment, generating the prompt comprises: replacing a placeholder in a prompt template with the determined information, the placeholder in the prompt template associated with the information type.

In an embodiment, the index recommendation comprises a command for creating a new index for the table.

In an embodiment, a system comprises: a processor; and a memory device comprising program code structured to cause the processor to: determine information associated with a table of a database; retrieve index recommendation guidelines; provide, to a large language model (LLM), a prompt requesting an index recommendation for the table, the prompt comprising the index recommendation guidelines and the determined information; receive, from the LLM, the index recommendation; and perform an action based on the index recommendation.

In an embodiment, to perform the action, the program code is structured to cause the processor to perform at least one of: provide the index recommendation to a user; provide, to the user, a reason for the index recommendation, the reason generated by the LLM based at least on the index recommendation guidelines; or automatically implement the index recommendation by creating an index for the table based on the index recommendation.

In an embodiment, to determine information associated with the table, the program code is structured to cause the processor to perform at least one of: retrieve missing index information from a missing index dynamic management view; retrieve a schema of the table from a first management view associated with the database; receive the schema of the table from a user; retrieve impactful workload information from a second management view associated with the database, the impactful workload information comprises a query statement associated with a query with a high impact on database performance; retrieve impactful workload information from a query data store associated with the database, the query data store comprising historical query information and performance information; or receive, from the user, impactful workload information, the impactful workload information comprising a query statement representative of an impactful workload.

In an embodiment, the index recommendation comprises at least one of: a ranked list of missing indexes determined based on the missing index information, the ranked list ranked in decreasing order of expected improvement of query performance associated with the table; a first recommended index for the table determined based on analysis of the schema of the table; a second recommended index for the table determined based on analysis of the impactful workload information; or a third recommended index for the table determined based on analysis of the schema of the table and the impactful workload information.

In an embodiment, the program code is further structured to cause the processor to: determine an information type of the determined information; and generate the prompt based on the information type of the determined information.

In an embodiment, to generate the prompt, the program code is structured to cause the processor to: replace a placeholder in a prompt template with the determined information, the placeholder in the prompt template associated with the information type.

In an embodiment, the index recommendation comprises a command for creating a new index for the table.

In an embodiment, a computer-readable storage medium comprises computer-executable instructions that, when executed by a processor, cause the processor to: determine information associated with a table of a database; retrieve index recommendation guidelines; provide, to a large language model (LLM), a prompt requesting an index recommendation for the table, the prompt comprising the index recommendation guidelines and the determined information; receive, from the LLM, the index recommendation; and perform an action based on the index recommendation.

In an embodiment, to perform the action, the computer-executable instructions, when executed by the processor, further cause the processor to perform at least one of: provide the index recommendation to a user; provide, to the user, a reason for the index recommendation, the reason generated by the LLM based at least on the index recommendation guidelines; or automatically implement the index recommendation by creating an index for the table based on the index recommendation.

In an embodiment, to determine information associated with the table, the computer-executable instructions, when executed by the processor, further cause the processor to perform at least one of: retrieve missing index information from a missing index dynamic management view; retrieve a schema of the table from a first management view associated with the database; receive the schema of the table from a user; retrieve impactful workload information from a second management view associated with the database, the impactful workload information comprises a query statement associated with a query with a high impact on database performance; retrieve impactful workload information from a query data store associated with the database, the query data store comprising historical query information and performance information; or receive, from the user, impactful workload information, the impactful workload information comprising a query statement representative of an impactful workload.

In an embodiment, the index recommendation comprises at least one of: a ranked list of missing indexes determined based on the missing index information, the ranked list ranked in decreasing order of expected improvement of query performance associated with the table; a first recommended index for the table determined based on analysis of the schema of the table; a second recommended index for the table determined based on analysis of the impactful workload information; or a third recommended index for the table determined based on analysis of the schema of the table and the impactful workload information.

In an embodiment, the computer-executable instructions, when executed by the processor, further cause the processor to: determine an information type of the determined information; and generate the prompt based on the information type of the determined information.

In an embodiment, to generate the prompt, the computer-executable instructions, when executed by the processor, further cause the processor to: replace a placeholder in a prompt template with the determined information, the placeholder in the prompt template associated with the information type.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

1. A method comprising:
retrieving missing index information from a missing index dynamic management view associated with a table of a database;
retrieving index recommendation guidelines;
providing, to a large language model (LLM), a prompt requesting an index recommendation for the table, the prompt comprising the index recommendation guidelines and the missing index information;
receiving, from the LLM, the index recommendation; and
performing an action based on the index recommendation.

2. The method of claim 1, wherein said performing an action comprises at least one of:
providing the index recommendation to a user;
providing, to the user, a reason for the index recommendation, the reason generated by the LLM based at least on the index recommendation guidelines; or
automatically implementing the index recommendation by creating an index for the table based on the index recommendation.

3. The method of claim 1, further comprising:
determining additional information associated with the table by performing at least one of:
retrieving a schema of the table from a first management view associated with the database;
receiving the schema of the table from a user;
retrieving impactful workload information from a second management view associated with the database, the impactful workload information comprises a query statement associated with a query with a high impact on database performance;
retrieving impactful workload information from a query data store associated with the database, the query data store comprising historical query information and performance information; or
receiving, from the user, impactful workload information, the impactful workload information comprising a query statement representative of an impactful workload.

4. The method of claim 3, wherein the index recommendation comprises at least one of:
a ranked list of missing indexes determined based on the missing index information, the ranked list ranked in decreasing order of expected improvement of query performance associated with the table;
a first recommended index for the table determined based on analysis of the schema of the table;
a second recommended index for the table determined based on analysis of the impactful workload information; or
a third recommended index for the table determined based on analysis of the schema of the table and the impactful workload information.

5. The method of claim 3, further comprising:
determining an information type of the determined additional information; and
generating the prompt based on the information type of the determined additional information.

6. The method of claim 5, wherein generating the prompt comprises:
replacing a placeholder in a prompt template with the determined additional information, the placeholder in the prompt template associated with the information type.

7. The method of claim 1, wherein the index recommendation comprises a command for creating a new index for the table.

8. A system comprising:
a processor; and
a memory device comprising program code structured to cause the processor to:
determine information associated with a table of a database;
retrieve index recommendation guidelines;
determine an information type of the information associated with the table;
access, based on the information type, a prompt template comprising a static textual component and a placeholder associated with the information type;
replace the placeholder in the prompt template with the determined information to generate a prompt comprising the index recommendation guidelines and the determined information;
provide the prompt to a large language model (LLM);
receive, from the LLM, the index recommendation; and
perform an action based on the index recommendation.

9. The system of claim 8, wherein, to perform the action, the program code is structured to cause the processor to perform at least one of:
provide the index recommendation to a user;
provide, to the user, a reason for the index recommendation, the reason generated by the LLM based at least on the index recommendation guidelines; or
automatically implement the index recommendation by creating an index for the table based on the index recommendation.

10. The system of claim 8, wherein, to determine information associated with the table, the program code is structured to cause the processor to perform at least one of:
retrieve missing index information from a missing index table;
retrieve a schema of the table from a first management view associated with the database;
receive the schema of the table from a user;
retrieve impactful workload information from a second management view associated with the database, the impactful workload information comprises a query statement associated with a query with a high impact on database performance;
retrieve impactful workload information from a query data store associated with the database, the query data store comprising historical query information and performance information; or
receive, from the user, impactful workload information, the impactful workload information comprising a query statement representative of an impactful workload.

11. The system of claim 10, wherein the index recommendation comprises at least one of:
a ranked list of missing indexes determined based on the missing index information, the ranked list ranked in decreasing order of expected improvement of query performance associated with the table;
a first recommended index for the table determined based on analysis of the schema of the table;
a second recommended index for the table determined based on analysis of the impactful workload information; or
a third recommended index for the table determined based on analysis of the schema of the table and the impactful workload information.

12-13. (canceled)

14. The system of claim 8, wherein the index recommendation comprises a command for creating a new index for the table.

15. A computer-readable storage medium comprising computer-executable instructions that, when executed by a processor, cause the processor to:
retrieve missing index information from a missing index dynamic management view associated with a table of a database;
retrieve index recommendation guidelines;
access a prompt template comprising a static textual component and a placeholder for missing index information;
replace the placeholder in the prompt template with the missing index information to generate a prompt comprising the index recommendation guidelines and the missing index information;
provide the prompt to a large language model (LLM);
receive, from the LLM, the index recommendation; and
perform an action based on the index recommendation.

16. The computer-readable storage medium of claim 15, wherein, to perform the action, the computer-executable instructions, when executed by the processor, further cause the processor to perform at least one of:
provide the index recommendation to a user;
provide, to the user, a reason for the index recommendation, the reason generated by the LLM based at least on the index recommendation guidelines; or
automatically implement the index recommendation by creating an index for the table based on the index recommendation.

17. The computer-readable storage medium of claim 15, wherein, the computer-executable instructions, when executed by the processor, further cause the processor to:
determine additional information associated with the table by performing at least one of:
retrieve a schema of the table from a first management view associated with the database;
receive the schema of the table from a user;
retrieve impactful workload information from a second management view associated with the database, the impactful workload information comprises a query statement associated with a query with a high impact on database performance;
retrieve impactful workload information from a query data store associated with the database, the query data store comprising historical query information and performance information; or
receive, from the user, impactful workload information, the impactful workload information comprising a query statement representative of an impactful workload.

18. The computer-readable storage medium of claim 17, wherein the index recommendation comprises at least one of:
a ranked list of missing indexes determined based on the missing index information, the ranked list ranked in decreasing order of expected improvement of query performance associated with the table;
a first recommended index for the table determined based on analysis of the schema of the table;
a second recommended index for the table determined based on analysis of the impactful workload information; or
a third recommended index for the table determined based on analysis of the schema of the table and the impactful workload information.

19. The computer-readable storage medium of claim 17, wherein the computer-executable instructions, when executed by the processor, further cause the processor to:
determine an information type of the determined additional information; and
generate the prompt further based on the information type of the determined additional information.

20. The computer-readable storage medium of claim 19, wherein, to generate the prompt, the computer-executable instructions, when executed by the processor, further cause the processor to:
replace the placeholder in the prompt template with the determined additional information, the placeholder in the prompt template associated with the information type.

21. The method of claim 1, wherein said index recommendation guidelines comprise reasoning behind various indexing options.

22. The system of claim 8, wherein said index recommendation guidelines comprise platform-specific syntax information.
